(19) United States
(12) Patent Application Publication
(10) Pub. No.: US 2011/0300527 A1
(43) Pub. Date: Dec. 8, 2011

(54) TEACHING METHOD

(76) Inventor: Allen Epstein, Calabasas, CA (US)

(21) Appl. No.: 13/214,210

(22) Filed: Aug. 21, 2011

Related U.S. Application Data
(63) Continuation-in-part of application No. 11/644,157, filed on Dec. 21, 2006, now Pat. No. 8,021,164.
(60) Provisional application No. 60/753,766, filed on Dec. 23, 2005.

(51) Int. Cl. G09B 25/00

(52) U.S. Cl. 434/365

(57) ABSTRACT

Aspects of the present invention include one or more of capturing educational presentations by presenters using instructional aids, making presentations available via the World Wide Web to users of educational services, aiding users in the selection of a particular topic and a particular presenter, rewarding students for achievement, and financially compensating presenters in accordance with the popularity of their educational presentations.

### CONTINUING APPLICATION AND PRIORITY CLAIM

This application is a continuation-in-part of U.S. patent application Ser. No. 11/644,157 filed Dec. 21, 2006 and claims the benefit of and incorporates by reference Provisional Application 60/753,766 filed Dec. 23, 2005.

### BACKGROUND OF THE INVENTION

1. Field of the Invention

The present invention relates to a method for teaching. In particular, the present invention relates to an improved method for providing educational content.

2. Background of the Related Art

Students have been taught using classroom-style educational presentations for millennia. More recently advances in the arts of computing and communications have enabled students to view educational content remotely. But, most of this educational content is generalized and lacks the breadth and coordination required to effectively cover typical subjects taught in schools and universities. Further, this content cannot generally be used to reinforce educational presentations a student witnesses in the classroom.

Despite advances in these technological building blocks, there remains a long felt need within the United States and other countries for ways and means to improve the educational process. This is especially the case in certain of the public schools of the United States. Despite this need and the large expenditures made by many entities responsible for the public education, the desired improvements have not, in the opinions of many, occurred. What is needed is a method for education that motivates the primary stakeholders, including teachers, teaching institutions and students, to leverage the capabilities of technology to solve this problem.

### SUMMARY OF THE INVENTION

Now, in accordance with the invention, there has been found a method for improving education by leveraging the capability to make educational presentations stored in digital media available to users of the Internet. In an embodiment, the method of the present invention includes a method of teaching comprising the step of aiding qualified users in the selection of an educational presentation from among a plurality of educational presentations, such presentations being stored in digital media accessible from the Internet and each such presentation teaching the same topic and being presented by a different presenter, by providing qualified users an indication of the popularity of at least two of the plurality of presentations.

In an embodiment, the method of the present invention is a method of teaching comprising the steps of, for qualified users, providing access via the Internet to a plurality of educational presentations stored in digital media, each said presentation teaching the same topic and being made by a different presenter, collecting financial compensation from a plurality of qualified users and a step for aiding qualified users in the selection of a particular educational presentation from the plurality of educational presentations, and, for at least one presenter, a step for determining an amount of financial compensation to be paid to such presenter.

In some embodiments the step for aiding users in the selection of a particular educational presentation further comprises the steps of obtaining a first indicia of popularity for each educational presentation by tracking the number of times each educational presentation has been replayed, inferring one or more presentation figures of merit from the first indicia of popularity, and, making at least one of the presentation figures of merit available to qualified users for use in selecting a particular educational presentation.

And in some embodiments, the step for aiding users in the selection of a particular educational presentation further comprises the steps of obtaining a second indicia of popularity for each presenter by tracking the number of times each presenter has been replayed, inferring one or more presenter figures of merit from the second indicia of popularity, and, making at least one of the presenter figures of merit available to qualified users for use in selecting a particular educational presentation.

In yet other embodiments, step for aiding users in the selection of a particular educational presentation further comprises the steps of obtaining a first indicia of popularity for each educational presentation by tracking the number of times each educational presentation has been replayed, obtaining a second indicia of popularity for each presenter by tracking the number of times each presenter has been replayed, inferring one or more combined figures of merit, each combined figure of merit being a function of both the first and second indicia of popularity, and making the combined figure of merit available to qualified users for use in selecting a particular presentation.

In another embodiment, the step for determining the financial compensation to be paid to at least one presenter further comprises the step of calculating at such presenter's financial compensation as a function of at least one figure of merit and/or student achievement such as student standardized test scores.

And in yet other embodiments, the step for aiding users in the selection of a particular educational presentation further comprises the steps of identifying users who receive regular classroom instruction from presenters carrying out their duties as teachers, and offering any such user the educational presentation made by such user's teacher when such user selects a topic for which an educational presentation by such teacher is stored in the digital media.

In various embodiments, a first figure of merit indicates the presentation popularity and a second figure of merit indicates the effectiveness of the presentation in boosting student performance. In some embodiments, the effectiveness figure of merit is derived from one or more student standardized test scores. And, in some embodiments, the presenter financial compensation also considers the popularity of the presenter's presentations amongst the presenter's peer presenters.

In various embodiments, student users are rewarded with virtual rewards as a function of student achievement. In some embodiments, the virtual rewards include points that can be accumulated by a student and exchanged for a valuable prize. In some embodiments, the virtual rewards include adulatory multi-media presentations. In some embodiments, the multi-media presentation portrays student recipient's peers via avatars and these avatar peers praise the student recipient's achievement. And, in some embodiments, the virtual rewards are private virtual rewards concealed from a student recipient's peers.

In various embodiments, student and presenter profiles are collected and utilized to suggest appropriate matches between students with presenters. In some embodiments, the profile data includes ethnicity data and first language data.

### BRIEF DESCRIPTION OF THE DRAWINGS

The present invention is described with reference to the accompanying figures. In the figures, like reference numbers indicate identical or functionally similar elements. The accompanying figures, which are incorporated herein and form part of the specification, illustrate the present invention and, together with the description, further serve to explain the principles of the invention and to enable a person skilled in the relevant art to make and use the invention.

FIG. 1 is a schematic of a setting for capturing an educational presentation according to one aspect of the present invention.

FIG. 2 is a schematic of a computing and communications infrastructure according to a second aspect of the present invention.

FIG. 3 is a depiction of a generalized navigating scheme according to a third aspect of the present invention.

FIG. 4 is a depiction of a particularized navigating scheme according to an alternative aspect of the present invention.

FIG. 5 is a depiction of a presenter menu according to a fourth aspect of the present invention.

### DESCRIPTION OF THE PREFERRED EMBODIMENTS

Aspects of the present invention include one or more of capturing educational presentations by presenters using instructional aids, making productions of these presentations available over an Internet connection to consumers of educational services, aiding selection of a particular topic and a particular presenter, and financially compensating presenters in accordance with the popularity of their educational presentations. In some embodiments students receive rewards such as virtual rewards and valuable prizes.

Educational presentations include any of dry sessions, class sessions, educational subject matter, topics, subjects, problems and reviews. Such presentations are produced for replay to consumers of educational services such as elementary, secondary school, college, graduate/professional students, and course reviews. In some embodiments educational presentations are produced for hobbyists such as golfers, enthusiasts such as amateur novelists, and others.

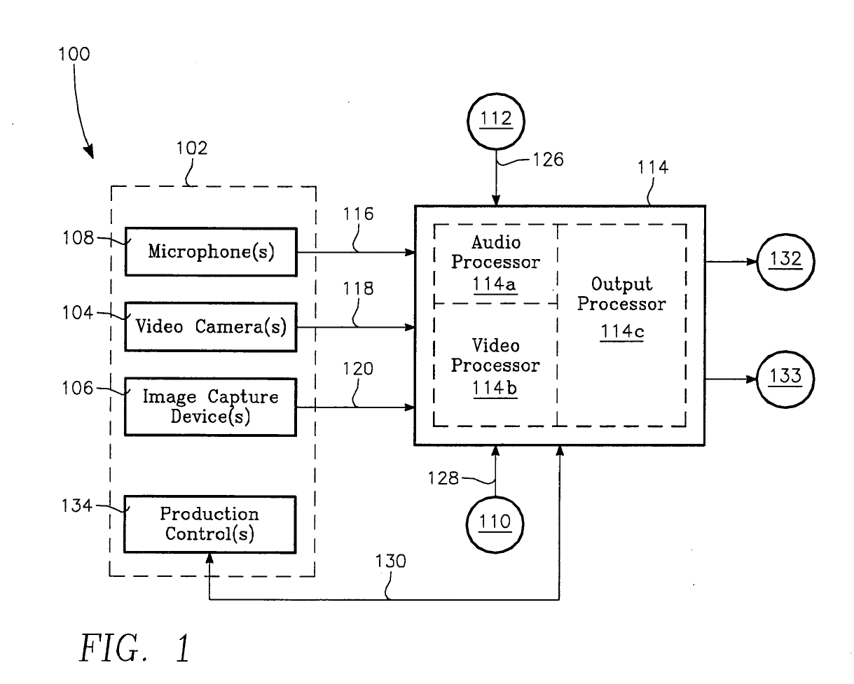

FIG. 1 shows an appropriately equipped setting 100 for capturing an educational presentation. Capturing a presenter's educational presentations occurs in any appropriately equipped setting 102 including for example an indoor/outdoor classroom or a studio-like setting. As used herein, the term “classroom” embodies these settings. Appropriate capture equipment includes video capture equipment 104 such as hobbyist, web and professional video cameras including CCD type cameras for capturing a video of the presenter, image capture equipment 106 such as electronic whiteboard/smart-board or document camera for capturing one or more of images and video of instructional aids including handwriting, and audio capture equipment 108 such as a directional microphone for capturing the voice of the presenter. In some embodiments, only the voice of the presenter becomes a part of the recorded presentation. As used herein, the term “video camera” embodies suitable video capture devices, the term “image capture device” embodies suitable image capture devices, the term “microphone” embodies suitable audio capture devices and the term suitable refers to such devices as are known to persons of ordinary skill in the art to be suitable for capturing an educational presentation incorporating the use of instructional aids.

As used herein, presenters include teachers and others capable of giving educational presentations and, educational presentations include the works of any such presenters that are useful for the purpose of educating. In various embodiments, users are presented with a visual display including the presenter and selected instructional aids. In addition, the user is presented with the voice of the presenter. In some embodiments, sub-text translation for the hearing impaired is included with the visual display. In some embodiments, the visual display includes one or more of additional instructional aids 110 such as movie or still image clips and content provided by a guest presenter and the audio includes audio 112, 126 from instructional aids and the guest presenter. And, in some embodiments, any of the visual content, such as a person speaking or displayed graphics or displayed text, and/or the audio content are presented to users.

The video signals 118 from the video camera(s) 104, image capture signals 120 from the image capture device(s) 106, and audio signals 116 from the microphone(s) 108 are processed in a multimedia processor 114 to produce and/or package, embed or encode an electronic representation of the educational presentation 132 such as mighty be produced by Microsoft® media products (e.g. .wmv file), Quicktime®, Instant Replay™ Tutor or Realplayer®. In some embodiments, additional image capture or video signals 110, 126 and additional audio signals 112 are also processed in the multimedia processor.

In an embodiment, the multimedia processor 114 includes a video processor 114b which receives the video signals 116, an audio processor 114a which receives the microphone signals, and an output processor 114c in signal communication with the video and audio processors. An output of the output processor 132 is a digital representation of the educational presentation including synchronized video and audio suitable for transport over an Ethernet or similar network capable of interfacing with the Internet. In an embodiment, an output of the output processor 133 is an electronic representation of the educational presentation suitable for creating a visual display in the classroom, such as when such electronic representation is received by a video projector or classroom computer. In some embodiments, additional image capture or video signals 110, such as video of a guest presenter, are processed by the video processor 114b and additional audio signals 112, such as pre-recorded music, are also processed in the audio processor.

The video processor 114b provides video switching functions for selecting among video sources 118, 120, 112. In an embodiment, the video processor enables formatting the visual display including picture-in-picture functionality for producing video displays having multiple frames such as a first frame displaying the presenter and one or more additional frames displaying other video or image content available to the multimedia processor 114. In some embodiments, the video processor provides transitions and background and foreground graphics to create four-layer effects.

The audio processor 114a provides audio switching and mixing functions for selecting among audio sources 116, 110 and mixing those sources. In an embodiment, the audio processor in combination with the video processor 114b provides synchronization between one or more audio sources and one or more video sources 118, 120, 112.

The output processor 114c provides the electrical interface between the audio and video processors 114a,b and the multimedia processor output 132. In some embodiments, the output processor includes an automated closed captioning feature capable of converting any of the audio sources 108, 112 into representative text in various languages and displaying the text in one or more frames of the visual display. And in some embodiments the audio of the presenter is replaced by a foreign language translation of the presenter audio.

In various embodiments, the multimedia processor 114 is one or more of an analog device, a digital device or a hybrid device. Where digital signals are inputs to the multimedia processor, they may be derived from a digital source such as a digital video camera or in the alternative result from an intermediate analog to digital conversion such as the conversion of an analog microphone signal to a digital representation of that signal. Similarly, where digital signals are inputs to the multimedia processor, they may be derived from an analog source such as an analog microphone or in the alternative result from an intermediate digital to analog conversion such as the conversion of a digital video camera signal to an analog representation of that signal.

A production control unit 134 is in signal communication 130 with the multimedia processor 114. The production control unit provides a man-machine interface to the multimedia processor for controlling the combined video-image-audio production of the educational presentation. In an embodiment (as shown), the production control unit is located in the classroom and is available to the presenter for pre-production set-up and adjustments made during the educational presentation for enhancing the effectiveness of the presentation.

An output of the multimedia processor 132 is a digital representation of the educational presentation. This representation or a version of it is stored in digital storage media (“storage device”) such as magnetic media, optical media, semiconductor media or another suitable media known to persons of ordinary skill in the art.

In various embodiments, one or more elements of the multimedia processor 114 may be embodied in a personal or other general or special purpose computer utilizing appropriate software such as Camtasia® (by TechSmith) and the like. In an embodiment, a discrete multimedia processor comprising a video processor and audio processor, such as the FOCUS MX-4 DV Digital Video Mixer or the Sony BVS-3200CP vision mixer, provides functionality similar to that of the multimedia processor 114 of the present invention.

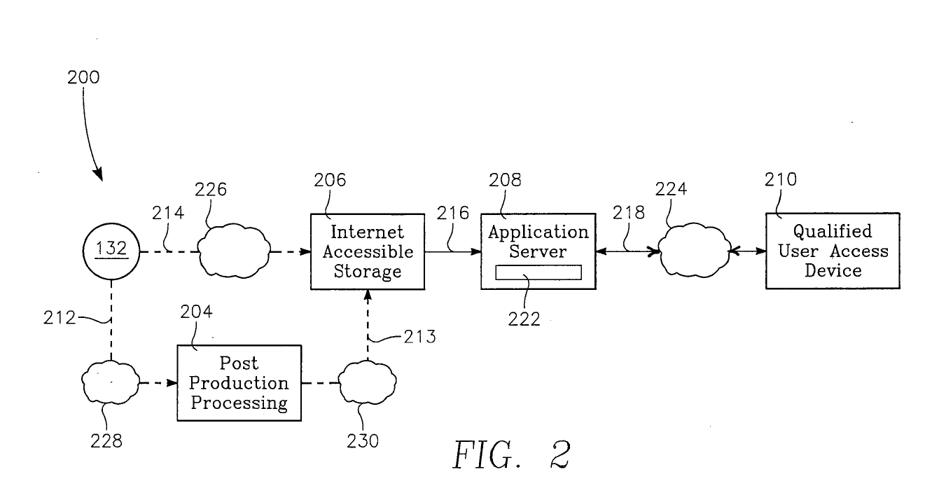

FIG. 2 shows a computing and communications infrastructure 200 for making educational presentations available via the Internet. Signal link 216 interconnects an application server 208 with an Internet accessible storage device 206 and signal link 218 interconnects the application server with user access devices 210 such as qualified user access devices. The digital representation of the educational presentation 132 is transmitted over signal link 214 and stored in the Internet accessible storage device 206. Access devices are devices such as personal computers, cell phones, virtual reality devices, personal digital assistants and the like 210 gain access to the stored presentations under control of the application server 208 running access and management software 222. Selection of a particular educational presentation by a user results in replay of the selected presentation or content. As used herein, “replay” includes streaming the content to a user's access device and downloading a digital representation of the content to a storage device available to a user's access device.

Suitable access and management servers include general purpose computer processors running Internet server software such as that offered by Microsoft® or Apache brand software and configured with an appropriate communications interface such as an Ethernet 10baseT interface. In an embodiment, the Internet accessible storage device receives the educational presentations via a post-production processing facility 204 having functionality similar to that in the multimedia processor 214 and typically operated by a person known as a “vision and audio mixer.” Here, the post-production processor receives the digital representation of the educational presentation over signal link 212 and transmits it, after post-production is completed, to the Internet accessible storage over signal link 213. In various embodiments one or more of signal links 212, 213, 214 and 218 pass through the facilities of an Internet Service Provider 228, 230, 226, 224.

The term “signal link” as used herein may be any digital transmission means including physical electrical conductors, physical optical conductors, any wireless means including the various IEEE 802 standards, and any other suitable means of signal transmission known to persons of ordinary skill in the art. The term “server” as used herein is broadly understood to mean any computing entity or family of such entities capable of responding to user requests over a network. The computing entities may be computer servers or server farms, general purpose digital computers, or special-purpose devices such as those having digital processors built in. The family of computing entities may be geographically distributed or may be “virtual” entities within a larger entity.

Similarly, “storage” or “storage device” when used here, is broadly understood to mean any of storage physically associated with a single location such as the storage devices of a particular educational institution or a particular internet service provider, storage distributed among a plurality of geographic locations including distributed storage which is accessible through an indexing means residing in a single location, and storage distributed as a part of a peer-to-peer file sharing application having indexing which may itself be distributed among a plurality of geographic locations.

A general purpose computer or application server of the present invention 208 utilizes application software 222 that provides for limited Internet access to educational presentations and performs various management functions. The limited access functionality of the software qualifies users who have exchanged financial compensation for use of the system or who have been granted access without financial compensation. Limiting access of Internet users to the educational presentations is accomplished by qualifying users. In various embodiments, qualification of a user includes one or more of qualification based on financial compensation received from the user, need based qualification, qualification on a trial basis, qualification as a presenter, and qualification for purposes of quality control and/or application monitoring.

In the present invention, not one, but a plurality of educational presentations are made available for selection by qualified users. Providing access to multiple presentations made by multiple presenters on the same topic lays a foundation for creating a competitive environment among presenters since consumers are given a choice. The management functionality of the software includes, processes for indexing and navigating to educational presentations, and retrieving and replaying lessons selected by qualified users. In various embodiments, the plurality of educational presentations includes one or more of multiple presentations by multiple presenters on a given topic, multiple presentations on a given topic by a single presenter, such as a course consisting of a series of topics, and a series of presentations by a plurality of presenters forming all or portions of a particular course.

Educational presentations may be identified according to any suitable indicia and system of indexing. For example, metadata such as one or more of the presenter's name, educational presentation title, production date, level, subject area, branch, course, topic, textbook, chapter, section and similar indicia provide one or more means of identifying a particular presenter or presentation. Other examples include functionality for searching within the audio, video or image portions of the presentation for particular phrases or content.

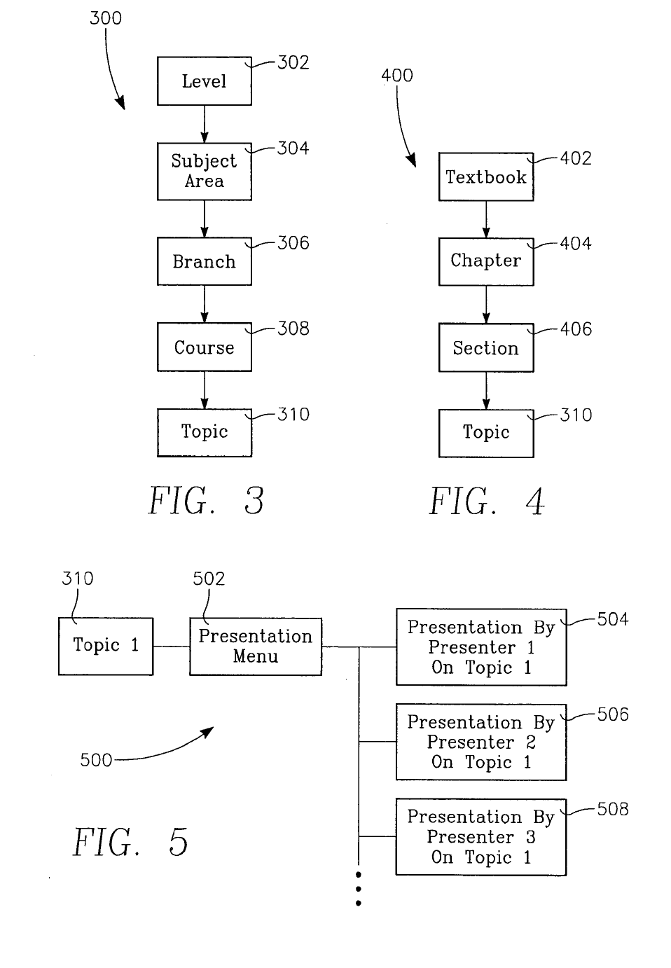

In an embodiment, a generalized navigation scheme is used. FIG. 3 shows a generalized navigating scheme 300. Here, the educational presentation is located by selecting in sequence the level (for example elementary, secondary, college, graduate, post-graduate or the like) 302, subject area (for example English, math, social sciences, life sciences, earth sciences or the like) 304, branch (for example English literature, English Grammar, English Poetry and the like) 306, course (for example beginning, intermediate, advanced and the like) 308, and topic (for example, gerunds, infinitives, proper nouns and the like). Upon making each of these choices, any of one or more stored or live presentations available on the particular topic are presented.

FIG. 4 shows another embodiment where a particularized navigating scheme 400 is used. Here, the educational presentation is located by selecting in sequence the textbook 402, chapter 404, section 406, and topic 310. Upon making each of these choices, any of one or more presentations available on the particular topic are presented. In an embodiment, a textbook lookup function provides locating a particular textbook by ISBN number, author, title and the like.

In yet another embodiment, navigation facilities include search based navigation. Here, potential search criteria include any available metadata that can be searched on such as level, subject area, branch, course, and topic. In some embodiments the metadata includes subtitles associated with the visual portion of presentations for the benefit of the hearing impaired. And in some embodiments, the subtitles are translations for the benefit of non-English speaking users. These subtitles provide searchable text suited to navigating to individual scenes within presentations. Searchable items within the subtitles include equations, specific words, topics, phrases, symbols, and other items of interest.

It is an advantage of the present invention that it creates a competitive marketplace for consumers of educational services by providing a choice among multiple presentations by multiple presenters relating to a particular topic. Thus in one such exemplary embodiment, a qualified user is presented with a first plurality of presentations wherein each of a second plurality of presentations is presented by a different presenter. As an example, FIG. 5 shows a presenter menu 500 wherein a presenter menu extends from a particular topic 310 and three presentations by different presenters extend from the presenter menu 502; the presentations of a) Presenter 1 on Topic 1 504, b) Presenter 2 on Topic 1 506, and c) Presenter 3 on Topic 1 508. By enabling a qualified user to choose from among several presentations on the same topic, a competitive marketplace is created wherein presenters compete for replays by consumers of educational services.

Users including student users and administrators must be qualified before access is granted. Qualification based on financial compensation received from the user results when the management software recognizes a particular user has paid a requested amount, such as through notification from PayPal® or another online payment service or when another pays directly or indirectly for the benefit of one or more users such as a payment made by a school district or third party donor. Need based qualification occur when third party or other reliable information concerning need is provided to an administrator of the present invention or through the management software such as notice that a user is eligible for subsidized public school meals. Trial basis qualification is provided to potential users requesting a trial account from the management software; such new users are identified by the management software based on information submitted by the potential user or otherwise acquired when the new user communicates with the management software. Typical trial user verifications include a comparison of the potential user's email address to the email addresses known by the present invention to be associated with past or present qualified users. Thus, in various embodiments, student users are qualified in a one to three tiered qualification system.

In some embodiments, student user qualification considers the student's state-of-mind. For example, a user's desire to learn is measured on a quantitative basis. Quantitative measurements include measurements derived from one or more of a) the length of time a student given a schoolwork task such as reading, writing or arithmetic will remain on task without prompting, b) the percentage of instruction followed when the student is given several instructions, and c) the number of tasks a student completes when given a group of simple tasks, such as bring a pencil, to be performed before attending a qualification session.

Presenters become qualified users by virtue of having one or more educational presentations available to qualified users. Other qualified users include those persons having responsibilities for quality control and/or application monitoring of the present invention. Notably, in some embodiments information about qualified users and/or their selections is withheld from presenters; in such embodiments, student identities and their selections are withheld from presenters. Yet other qualified users include presenters or would be presenters seeking professional development and/or school administrators seeking evaluation for teaching capabilities.

In an embodiment, profiles of potential users are obtained and stored by the management software 222 during the qualification process. Where the potential user is a student, the profile will typically include a) a bio with ethnicity-gender-age, b) first language and language proficiencies, c) information relating to the learning institution and presenters the student is associated with, if any, and d) the learning styles best suited to the student such as visual learner, audible learner, tactile learner, accent, and the like. In some embodiments, student preferences identifying from whom a student prefers to learn are also included in the student profile. In some embodiments, student preferences identifying from whom a student believes to be the best presenter are also included in the student profile.

And, in various embodiments, profiles of the presenters are obtained by one or more of the user qualification process above and entry at the time of pre or post production by the presenter or on the presenter's behalf. The presenter profiles will typically include a) a bio of the presenter including ethnicity-gender-age, b) first language and language proficiencies, and c) an indication of the types of student learning styles best suited to the presenter's presentation and teaching styles. For example, an immigrant student having trouble in math might be matched with a math presenter known for a slow and methodical teaching style and having roots in the same ethnic community as the student. In various embodiments, the management software suggests well matched presenters given a particular student's profile or, in some embodiments, based on post-test results for other students with similar backgrounds and learning styles.

Financial transactions performed by the management software include one or more of presenting new users or qualified users with requests for compensation, receiving compensation, and verifying that compensation has been received unless the subscription was gifted by a school system or a third party. In an embodiment, a potential user requesting access to educational presentations is presented with options and corresponding amounts to purchase a particular presentation, a particular set of presentations or unlimited access. Potential users desiring to complete the financial transaction are directed to enter the credit card or other account which will be used to satisfy the management software's request for compensation. Upon confirmation that the request has been satisfied, the user's account is updated by the management software to recognize receipt of payment. In some embodiments, the management software provides a link to a funds transfer service such as PayPal®. The funds transfer service in turn provides secure transfer of funds from a user's existing credit card or bank account to an email address associated with the present invention's owners, operators, designated beneficiaries or their agents, the same being designated to receive such payments.

The management software functionality also includes processes for generating statistics indicative of popularity of presentations and presenters, and conducting financial transactions. Statistics indicative of presentation and presenter popularity include tracking the number of times each educational presentation has been replayed and the number of times each presenter has been replayed. Such statistical data provide a quantitative means for enabling qualified users to select the most popular presentations and/or presenters. In an embodiment, this tracking functionality is implemented by constructing a popularity array having a number of rows equal to the total number of presentations “np” tracked by the management software. Table 1, Array Structure, shows the structure of one such array.

TABLE 1
Array Structure

| | | | | Presenter | | |
|---|---|---|---|---|---|---|
| i^{th} | | | Presen- | Replays | | |
| Presen- | k^{th} | | tation | Presen- | Presenter | Presenter |
| tation | Topic | Presenter | Replays | ter 1 | 2 | 3 |
| 1 | 1 | presenter 1 | r1 | r1 | | |
| 2 | 2 | presenter 1 | r2 | r2 | | |
| 3 | 1 | presenter 2 | r3 | | r3 | |
| 4 | 3 | presenter 3 | r4 | | | r4 |
| 5 | 3 | presenter 1 | r5 | r5 | | |
| 6 | 3 | presenter 2 | r6 | | r6 | |
| 7 | 1 | presenter 3 | r7 | | | r7 |
| 8 | 2 | presenter 2 | r8 | | r8 | |
| 9 | 2 | presenter 3 | r9 | | | r9 |
| | | | totals | tot1 | tot2 | tot3 |
| | | | entries | 3 | 3 | 3 |
| | | | average | tot1/3 | tot2/3 | tot3/3 |

In a representative embodiment, the management software tracks a total of “np” presentations, a particular presentation being the i^{th} presentation, and a total of “nt” topics, a particular topic being the k^{th} topic. In this example embodiment, each of the presentations is by one of three presenters identified as Presenter 1, Presenter 2, or Presenter 3. For each presentation, a corresponding counter “presentation replays” maintains a numeric value “rᵢ” equal to the number of times the presentation has been replayed. The popularity of a particular presentation is therefore indicated by its corresponding rᵢ value in the presentation replays column.

Here, an indication of the popularity of a particular presenter is maintained in presenter columns in the popularity array. In each presenter's column, the number of presentation replays corresponding to a particular presentation is entered if the presenter made the presentation. For example, in the Presenter 1 column of the popularity array, the values r1, r2 and r5 are entered by the management software since these replays relate to presentations made by Presenter 1. An indication of the popularity of Presenter 1 is therefore “tot1” which is the total number of presentation replays credited to Presenter 1 (r1+r2+r5). Another indication of the popularity of Presenter 1 is “tot1/3” which is the average number of replays of each of Presenter 1's presentations ((r1+r2+r5)/3).

In an embodiment, indicated presentation popularity and indicated presenter popularity serve as “figures of merit,” or as a basis for deriving and/or inferring figures of merit, for use by qualified users in selecting a particular presentation. Figures of merit also include mathematical functions of one or more of the indicated presenter popularity and indicated presentation popularity such as sums, averages and statistical functions known in the art of any of these values. Still other figures of merit may also be derived and/or inferred from indicated popularities by, for example, combining the indicated presentation popularity and the indicated presenter popularity. As a further example, Table 2, Popularity Array, contains the following data.

TABLE 2
Popularity Array

| | | | Presen- | Presenter | | |
|---|---|---|---|---|---|---|
| i^{th} | | | tation | Replays | | |
| Presen- | k^{th} | | Replays | Presen- | Presenter | Presenter |
| tation | Topic | Presenter | (rᵢ) | ter 1 | 2 | 3 |
| 1 | 1 | presenter 1 | 12 | 12 | | |
| 2 | 2 | presenter 1 | 22 | 22 | | |
| 3 | 1 | presenter 2 | 12 | | 12 | |
| 4 | 3 | presenter 3 | 4 | | | 4 |
| 5 | 3 | presenter 1 | 3 | 3 | | |
| 6 | 3 | presenter 2 | 15 | | 15 | |
| 7 | 1 | presenter 3 | 8 | | | 8 |
| 8 | 2 | presenter 2 | 13 | | 13 | |
| 9 | 2 | presenter 3 | 28 | | | 28 |
| | | | totals | 37 | 40 | 40 |
| | | | entries | 3 | 3 | 3 |
| | | | average | 12.3 | 13.3 | 13.3 |

A qualified user seeking educational services relating to topic 1 has three presentations to choose from (1, 3 and 7) and each of these presentations has a presentation replay count (12, 12 and 8). Given these values, a qualified user might likely select either of Presenter 1 or Presenter 2 (Set 1=(Presenter 1, Presenter 2)).

In similar fashion, a qualified user seeking educational services relating to topic 1 has three presenters to choose from (Presenters 1, 2 and 3) and each of these presenters has a presenter replay count (37, 40 and 40) and a normalized presenter replay count (12.3, 13.3 and 13.3). Given these values alone, a qualified user might likely select either Presenter 2 or Presenter 3 (Set 2=(Presenter 2, Presenter 3)). However, if the qualified user also has access to the presentation replay counts, he might likely select Presenter 2 as the “best” given the replay counts for both presentations and presenters support this choice. In an embodiment, a combined figure of merit considering both popularity of the presentation and popularity of the presenter, the intersection of Sets 1 and 2, is made available to qualified users as an aid in selecting a particular presentation.

As will be understood by persons of ordinary skill in the art, the popularity statistics discussed above may also be generated in a similar fashion for subject area 304, branch 306, and course 308. In an embodiment, presentation of these intermediate popularity statistics, for example during the navigation process, provides qualified users with additional criteria for selecting particular presenters. In some embodiments, information about qualified users and their selections is withheld from presenters. And in some embodiments a presenter and the presenter's peers have access to statistics showing the presenter's number of students and the success (such as indicated by an effectiveness metric) of those students. In a similar fashion, embodiments provide school districts supporting particular users with access to statistics showing presenter metrics and student metrics for sponsored users and their presenters and additional metrics for presenters presenting outside their school system.

In an embodiment, the time period from which the replay data is selected is pre-determined. In some embodiments the time period from which the replay data is selected is selectable by a qualified user. This functionality is of particular interest for example where data is available for a presenter over a relatively long period of time and the replay counts for the presenter and the presenter's related presentations have experienced significant change with time. And in some embodiments, it is only when selected users, such as students, request an educational presentation that a replay occurs for the purposes of popularity statistics. And in some embodiments, multiple replays by the same student within the same school term for a particular presenter and presentation count for only 1 replay for the purposes of popularity statistics.

Further, persons of ordinary skill in the art will recognize that the method(s) described above for monitoring the popularity of selected content on the Internet is but one of many similar methods that may be implemented on a general purpose computer running suitable software. For example, students who are qualified users may provide a rating of the presentation during a session and these ratings may also be used to identify for future qualified users the most popular presentation(s). In addition, qualified users participating in forums hosted by a web site offering the service of the present invention may provide popularity data for the purpose of obtaining and making available to qualified users additional ranking data.

Some embodiments utilize other metrics, alone and in combination with the above metrics, in the evaluation and rating of presenters and their presentations. These other metrics include peer popularity metrics and effectiveness metrics.

For example, popularity metrics based on presentation replays can be based on student replays, peer (presenter) replays, and combinations of the two. In the case of peer replays, other teachers can view the presentations of their peers to improve their own presentations. For example, a math presenter may watch other math presenters, such as the most popular math presenters based on student replays, to make the content of their presentations and their delivery style more popular with students. In an embodiment, these peer popularity metrics are assembled and utilized in a manner similar to the assembly and utilization of student popularity data.

Effectiveness metrics provide a means to evaluate and rate presenters and presentations based on outcome and/or improvement in outcome. For example, student test scores or the improvement in student test scores provides a metric for judging which presenters and presentations best provide the desired outcome, a high test score or a large test score improvement. In various embodiments, standardized test scores and non-standardized test scores are used. Notatably, test scores provide quantitative measures of student achievement. Other effectiveness metrics include student attendance and teacher evaluations provided by students. Student attendance metrics include the number of presentations in a series of presentations that are timely attended by the student. Teacher evaluation metrics include numeric scores provided by students to rate presenters in one or more presenter performance categories.

In various embodiments, any one of or any combination of student replay popularity, peer replay popularity, and effectiveness is used in evaluating and rating presenters and their presentations. For example, figures of merit or values for each metric can simply be added together to produce a total. In other embodiments, a figure of merit for each metric can be multiplied by a weighting factor before the addition to give particular emphasis to individual metrics.

In various embodiments, the present invention includes one or more of systems and methods for matching qualified users with appropriate presenters, acquiring educational presentations, rewarding presenters, protecting copyrights subsisting in educational presentations, and reinforcing instruction users have previously received.

In addition to the methods for selecting presentations and presenters above, in an embodiment, students who are qualified users are matched with appropriate instructors. This matching is accomplished by analyzing profiles provided by each presenter and each student who is a qualified user. For example, a presenter profile evidencing a presentation style best suited for visual learners will be suggested by the management software to students whose profile suggests a preference for this learning style. Other examples include matching accents such as matching a Hispanic presenter with a Hispanic student. In an embodiment, the matching works to provide a role model for the student.

In an embodiment, educational presentations are acquired under an exclusive contract with entities employing presenters. For example, a particular school board or university entity is solicited and offered a contract which includes selected faculty members. Motivation for entering such a contact includes one or more of free access for selected students, improved student knowledge and performance such as higher standardized test scores, public relations, financial compensation for the employing entity and financial compensation for the presenter.

Financial compensation for presenters is, in an embodiment, dependent upon one or more of the afore mentioned or similar figures of merit including those derived from statistics of the popularity of presentations and presenters. In some embodiments, presenter compensation considers the improvement in user test scores. For example, in one embodiment presenter financial compensation is based on the sum of the figures of merit of student popularity, peer popularity, and test score improvement where the popularity metrics include presentation and presenter popularity. And, in another example, presenter financial compensation is based on the sum of the figures of merit of test score improvement and student popularity.

In some embodiments, a fraction of the net income resulting from operation of the present invention is set aside as compensation for presenters. For example, for a particular period of time, a presenter's replays are calculated as a fraction of the total replays and the presenter's financial compensation is that percentage multiplied by the net income set aside during the period. (e.g. [(tot1/sum(r1 . . . r9)*net income set aside]) (See Table 1). Financial compensation paid to presenters based on the popularity of their educational presentations tends to increase competition among presenters since presenters have a financial stake in making educational presentations and in improving the popularity of their presentations. And in some embodiments, presenters must reach a threshold level of presenter and/or presentation popularity, such as the upper quartile, before any financial compensation is paid. And in some embodiments, presenters must reach a threshold level of compensation before a payment is due.

Financial compensation for the entity is, in an embodiment, dependent upon the financial compensation awarded to presenters. Here, a fraction of the compensation received by the employees of the entity is paid to the entity. For example, where the employees of an entity receive total compensation of $100 in a particular period, the entity would receive compensation equal to 25% of this amount or $25. Financial compensation paid to the employers of presenters based on the popularity of the employee's educational presentations tends to increase competition among presenters since it can be expected that financial compensation to employers will motivate employers to encourage employees to make educational presentations and to improve the popularity of those presentations. Still other methods of allocating a fixed amount or a fraction of a fixed amount to potential recipients such as presenters and/or their employers, including need based allocations and allocations based on standardized test scores, are known to persons of ordinary skill in the art.

In some embodiments, students receive rewards such as virtual rewards and/or financial rewards. Here, such students become eligible to receive rewards based on merit, and in particular, merit associated with the student's academic performance as evidenced by improved performance or reaching a particular level of performance. Typical performance metrics include test scores such as standardized test scores. Rewards are set, in various embodiments, at levels including average achievement and better than average achievement on tests such as standardized tests. Rewards are also set, in various embodiments, at levels including average achievement and better than average achievement as compared with the student's peer group such as others viewing the same presentation(s).

Virtual rewards are, in some embodiments, presented privately to a student recipient while in other embodiments virtual rewards are not presented privately to a student recipient. In contrast, and as discussed below, private virtual rewards are presented privately in every case.

Virtual rewards are not financial rewards and they include recognition and/or praise of the student recipient. In various embodiments, one or more of the below mentioned virtual rewards are available to student recipients. Notably, where advisable (e.g. peers view academic success in a negative light), student rewards are conveyed privately to the student recipient. Simple virtual rewards include computer conveyed messages presented to the student recipient in straightforward terms such as a text message. Additional virtual rewards include certificates suitable for printing or on-screen medallions of varying forms and colors, akin to a modern day “gold star.”

More complex virtual rewards include adulatory presentations such as multi-media presentations that are presented to the student recipient. Customized virtual rewards include multi-media presentations where the student recipient, the student recipient's peers, or the student recipient's presenter(s) are portrayed in the multi-media presentation. In one embodiment, both the student recipient and the student's recipient's peers are portrayed by their respective avatars in an adulatory multi-media presentation recognizing and praising the student recipient.

A subset of virtual rewards is private virtual rewards. Private virtual rewards are delivered to a student recipient in a manner that conceals the reward from the student's peers. Private virtual rewards are intended to offer a student recipient a reward that can be enjoyed without subjecting the student recipient to kidding, teasing, and other offensive behaviors of the student recipient's peers or another person or group exhibiting such behaviors. In various embodiments, private virtual rewards are delivered to the student recipient using private means such as a computer or personal computer. In one embodiment, private virtual rewards are delivered via an email account of the student recipient.

In various embodiments, winners of a virtual reward receive an entry into a randomized drawing for a valuable reward. For example, a student receiving three virtual rewards in a particular drawing period would be entered three times for the drawing. In various embodiments, virtual rewards received by a particular student have a cumulative value that can be exchanged for a valuable prize. For example, in some embodiments, a student recipient who collects “points” associated with ten virtual rewards can exchange the points for a valuable gift such as an i-Tunes® gift card or in cases, an i-Pod® player.

In an embodiment, one or more virtual reward points correspond to each virtual reward; one or more virtual reward chances correspond to each virtual reward; one or more valuable prizes is offered in exchange for a student's accumulated virtual reward points; and, each virtual reward chance is operable to provide its student owner with a chance to win a valuable prize in a random drawing for prizes.

Presenters typically have copyrights subsisting in the educational presentations of the present invention. In addition a third party, such as a university employing a presenter, may have acquired rights in the work(s) of an employed presenter. In an embodiment, presenters and third party rights holders assign or provide licenses to their copyrights in particular educational presentations to an entity (“the copyright transferee”) who holds those rights for the benefit of the owners, operators, qualified users and/or beneficiaries of the present invention. And in an embodiment, the copyright transferee is the same entity that operates the teaching method infrastructure.

In an embodiment, the rights of the copyright transferee are in turn protected by one or more of licenses executed as a condition of becoming a qualified user and managing digital rights via protecting and securely delivering educational presentations for playback on qualified user access devices 210 including computers, portable devices, and network devices. Suitable Digital Rights Management (“DRM”) platforms known in the art include Microsoft Media Digital Rights Management and Apple's Fairplay Digital Rights Management System (Microsoft and Apple are registered trademarks of Microsoft Corporation and Apple Computer, Inc. respectively.) Where the Microsoft product is used, the DRM software typically resides on the application server 208 and no corresponding special purpose client application will be required on a qualified user access device.

Some presenters will have students attending their educational presentations who are qualified users of the present invention (“attending qualified users”). For example, users who receive regular classroom instruction from presenters carrying out their duties as teachers. In an embodiment, this relationship can be identified by the management software. For example, the relationship may be identified by one or more of information the student provides during the process of becoming a qualified user, information the presenter or one acting on behalf of the presenter or the presenter's employer provides before or during the time a student is enrolled in the related class, or other similar methods. Notably, the access granted an attending qualified user may be denied in cases where that user fails to physically attend live classes of the presenter.

In an embodiment of the present invention, a hybrid topic selection process is presented to attending qualified users. Here, an attending qualified user requesting a topic available from his instructor will be offered the presentation of his instructor first. If the student declines this offer, all of the selection methods discussed above are then made available to guide the student in the selection process. In an embodiment, this hybrid functionality offers attending qualified users their own instructor in a manner similar to the Google® presentation of a paid search link, the offering of the user's own instructor being presented in similar manner to the offering of a paid search link.

As seen above, some embodiments of the invention utilize multimedia presentations. In yet other embodiments, presentations are limited to any of visual content, such as any of text or graphics, and/or audio content such as any of a person speaking, a person reading, and music making. For example, audio book presentations can be used in teaching in a manner similar to that described above for multimedia presentations. And in another example, textural and/or graphic book presentations can be used in teaching in a manner similar to that described above for multimedia presentations.

In some embodiments, the creator of the work being presented is deemed to be the presenter. In an embodiment, the person deemed to be the presenter is the author of a book to be presented to users as readable text content. In an embodiment the person deemed to be the presenter is the author of a book to be presented to users as listenable audio content. In an embodiment the person deemed to be the presenter is the creator of an artistic work to be presented to users as viewable graphic content. And, in an embodiment, the person deemed to be the presenter is the creator of a musical work to be present to users as listenable content.

While various embodiments of the present invention have been described above, it should be understood that they have been presented by way of example only, and not limitation. It will be apparent to those skilled in the art that various changes in form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A method of teaching comprising the step of aiding qualified users in the selection of an educational presentation from among a plurality of educational presentations, such presentations being stored in digital media accessible from the Internet and each such presentation teaching the same topic and being presented by a different presenter, by providing qualified users with a user derived figure of merit for at least two of the plurality of presentations.

2. A method of teaching comprising the steps of:
for qualified users, providing access via the Internet to a plurality of educational presentations stored in digital media, each said presentation teaching the same topic and being made by a different presenter;
collecting financial compensation from a plurality of qualified users;
aiding qualified users in the selection of a particular educational presentation from the plurality of educational presentations;
for at least one presenter, determining an amount of financial compensation to be paid to such presenter; and,
for at least one student, determining a virtual reward to be presented to the student.

3. The method of claim 2, wherein the step for aiding users in the selection of a particular educational presentation further comprises the steps of:
obtaining a first user derived indicia of popularity for each educational presentation by tracking the number of times each educational presentation has been replayed;
inferring one or more presentation figures of merit from the first indicia of popularity; and,
making at least one of the presentation figures of merit available to qualified users for use in selecting a particular educational presentation.

4. The method of claim 3, wherein the step for aiding users in the selection of a particular educational presentation further comprises the steps of:
obtaining a second user derived indicia of popularity for each presenter by tracking the number of times each presenter has been replayed;
inferring one or more presenter figures of merit from the second indicia of popularity; and,
making at least one of the presenter figures of merit available to qualified users for use in selecting a particular educational presentation.

5. A method of teaching comprising the steps of:
aiding qualified users in the selection of an educational presentation from among a plurality of educational presentations, such presentations being stored in digital media accessible from the Internet and each such presentation teaching the same topic and being presented by a different presenter, by providing qualified users with a figure of merit for at least two of the plurality of presentations; and,
financially compensating presenters as a function of at least two figures of merit.

6. The method of claim 5 wherein the first figure of merit indicates the presentation popularity and the second figure of merit indicates the effectiveness of the presentation in boosting student performance.

7. The method of claim 6 wherein the effectiveness figure of merit is derived from one or more student standardized test scores.

8. The method of claim 6 wherein presenter financial compensation also considers the popularity of the presenter's presentations amongst the presenter's peer presenters.

9. The method of claim 5 wherein student users are rewarded with virtual rewards as a function of student achievement.

10. The method of claim 9 wherein virtual rewards include points that can be accumulated by a student and exchanged for a valuable prize.

11. The method of claim 9 wherein the virtual rewards include adulatory multi-media presentations.

12. The method of claim 11 wherein the multi-media presentation portrays the student recipient's peers via avatars and these avatar peers praise the student recipient's achievement.

13. The method of claim 12 wherein the virtual rewards are private virtual rewards.

14. The method of claim 5 further including the steps of:
collecting student profiles;
collecting presenter profiles; and,
utilizing student and presenter profile data to suggest appropriate matches between students with presenters.

15. The method of claim 5 wherein profile data includes ethnicity data and first language data.

16. A method of teaching comprising the steps of:
providing educational presentations for the benefit of school students;
for qualified users, providing access via the Internet to the educational presentations stored in digital media, each said presentation teaching the same topic and being made by a different presenter;
aiding qualified users in the selection of a particular educational presentation from the plurality of educational presentations;
obtaining a first indicia of popularity for each educational presentation by tracking the number of times each educational presentation has been replayed;
obtaining a second indicia of popularity for each presenter by tracking the number of times each presenter has been replayed;
providing financial compensation to presenters based on the first and second indicia of popularity; and,
rewarding students with virtual rewards according to a quantitative measure of student achievement.

17. The method of claim 16 further including:
one or more virtual reward points corresponding to each virtual reward;
one or more virtual reward chances corresponding to each virtual reward;
one or more valuable prizes being offered in exchange for a student's accumulated virtual reward points; and,
each virtual reward chance operable to provide its student owner with a chance to win a valuable prize in a random drawing for prizes.

18. The method of claim 17 wherein the virtual rewards include adulatory multi-media presentations.

19. The method of claim 18 wherein the multi-media presentation portrays the student recipient's peers via avatars and these avatar peers praise the student recipient's achievement.

20. The method of claim 19 wherein the virtual rewards are private virtual rewards.

21. The method of claim 20 further including:
a first figure of merit based on the first and second indicia of popularity;
a second figure of merit based on the student standardized test scores; and,
wherein presenter compensation is a function of the first and second figures of merit.

22. The method of claim 19 wherein the creator of the work being presented is deemed to be the presenter.

23. The method of claim 22 wherein the person deemed to be the presenter is the author of a book to be presented to users as readable text content.

24. The method of claim 22 wherein the person deemed to be the presenter is the author of a book to be presented to users as listenable audio content.

25. The method of claim 22 wherein the person deemed to be the presenter is the creator of an artistic work to be presented to users as viewable graphic content.

26. The method of claim 22 wherein the person deemed to be the presenter is the creator of a musical work to be presented to users as listenable audio content.
